(19) United States
(12) Patent Application Publication
(10) Pub. No.: US 2011/0045308 A1
(43) Pub. Date: Feb. 24, 2011

(54) COATED WOOD BOARD

(75) Inventors: Samantha Kiljunen, Lappeenranta (FI); Raija Rautiainen, Lahti (FI); Juha Patovirta, Hollola (FI); Ilkka Tarvainen, Lahti (FI)

Correspondence Address: MERCHANT & GOULD PC, P.O. BOX 2903, MINNEAPOLIS, MN, 55402-0903, US

(73) Assignee: UPM-KYMMENE WOOD OY, Lahti (FI)

(21) Appl. No.: 12/918,285

(22) PCT Filed: Feb. 18, 2009
(86) PCT No.: PCT/FI2009/050132

§ 371 Date: Nov. 11, 2010

(30) Foreign Application Priority Data
Feb. 18, 2008 (FI) 20085148
May 16, 2008 (FI) 20085464

(51) Int. Cl. B32B 21/08

(52) U.S. Cl. 428/438; 428/513

(57) ABSTRACT

The invention relates to a coated wood board, in which the wood board is coated with a coating material. In accordance with the invention, the coating material is formed of polyolefin film, and polyolefin film is at least partially cross-linked so that the percentage of cross-linking is 10-60% bigger than the polyolefin amorphous percentage for pinning two phases, crystalline and amorphous, together for forming a wear and heat resistant coating.

### FIELD OF THE INVENTION

The invention relates to a coated wood board as defined in the preamble of claim 1.

### BACKGROUND OF THE INVENTION

Known from prior art are various wood boards and methods for manufacturing wood boards. These products need often a coating over them to protect the base product or to give some specific surface property to them.

Coatings used for wood products are normally some organic polymers, very often resins like phenolic resins and melamine resins. Thermoplastic coatings are also used, but the problem with them is how to adhere them to wood panels or products. Polymer priming is one method with the use of hot-melt glues.

For preparing the wood board resins and various gluing material are used to glue and join together veneers of the wood board. Known from prior art is to glue coating onto the wood board, e.g. with a polyurethane or phenolic glue.

Also known is to use maleated polyethylene (MAPE) or maleated polypropylene (MAPP) for making wood fiber-polymer composites, where the maleated polymer is used as a coupling agent between the fiber and polymer. Known is that cellulose fibers can be surface modified with polypropylene-maleic anhydride copolymer.

Further, known from patent application EP 0782917 is the preparation of a coated board with extruded films. The film comprises in one embodiment maleic anhydride grafted ethyl-vinyl acetate co-polymer (MA-g-EVA). No treatment, e.g. no activation, of the film during film manufacture is employed.

Resistance against wearing forces and heat due to, for example, a wheel spinning in place and at the same time resistance against rolling at high spot pressure is not an easily achieved goal in floor surface coatings and materials. Both requirements are needed at the same time when cargo is loaded or unloaded from vehicles via ramps or similar arrangements. Manually operated pallet trucks can carry over one ton of load supported only with 4 small wheels. So the local, spot-like surface pressure is very high.

The spinning test is used to identity surface resistance against melting, when a wheel is accurately rotating in one place, over a short period of time, thus simulating a real life situation of, for example a pallet truck carrying high load and turned within a limited space. Passing such spinning tests requires that surface melting should not happen and passing the rolling test requires that the surface layers underneath are jointly flexible enough to withstand many cycles of local rolling pressure.

Earlier in the related art, where mainly plywood was coated for such purposes, multiple layered coatings where used, where polyamide layers formed the flexibility and phenolic layers formed required hardness. The total number of required layers was 12-18. Known problems with phenolic films is the colour and impression that such colour is related to unhygienic conditions. This method and the structures are described in FI 110495 patent.

U.S. Pat. No. 7,156,944 describes a solution how certain adhesives can prevent them of becoming too brittle, by limiting cross-linkable materials amount in polymer mixtures.

In the polymer market there does not exist many suitable materials for this purpose and other suitable materials are very expensive making them uninteresting for such applications. The possibility to modify polymer materials for suitable desired hardness/flexibility relation is limited.

### OBJECTIVE OF THE INVENTION

The objective of the invention is to disclose a new type of a coated wood board. The invention aims to solve coating of the wood board with a complete new and very simple way.

### SUMMARY OF THE INVENTION

A coated wood board according to the invention are characterized by what is presented in the claims.

The invention is based on a coated wood board, in which the wood board is coated by a coating material. The wood board is formed so that the veneers of the wood board are joined together. In accordance with the invention, the coating material is formed of polyolefin film, and the polyolefin film is at least partially is cross-linked so that the percentage of cross-linking is 10-60% bigger than the polyolefin amorphous percentage for pinning two phases, crystalline and amorphous, together for forming a wear and heat resistant coating. If cross-linking is too high, the material will become brittle; however, if it is too low the material will still melt under wearing/stressing conditions.

The invention is specifically based on the heat and wear resistant wood board having the near similar surface hardness than birch wood plywood. The coating is based on the hard wood coating.

In this context, a wood board refers to any wood panel product, plywood product, composite product, particle board, fiberboard, beam, pressed panel product or the like, formed of a number of veneers and principally of wood-based materials, in which the veneers are laid one upon the other and glued together. Further, a wood board refers to any wood product or fiber product. In this context, a veneer refers to any layer of material, typically a thin layer of material. In a preferable embodiment the wood board is plywood.

A wood board according to the invention can comprise veneer layers of different thickness. The thicknesses of the veneer layers can vary. The veneer layers can be arranged in the desired position, i.e. crosswise or lengthwise in the desired order.

In one embodiment of the invention the polyolefin film comprises at least two layers and at least top layer which is the first layer is cross-linked.

In one embodiment at least one additive layer is arranged between the first and second layers. In one embodiment the film can comprises more than one additive layers e.g. 2-10 additive layers. In one embodiment the additive layers can contain functional additive. In one embodiment the additive layer can contain, for example, fire retardants, UV-stabilisers and fillers.

In one embodiment of the invention the polyolefin film is at least partially cross-linked. In one embodiment the first layer is at least partially cross-linked. In on embodiment the second layer is at least partially cross-linked. In one embodiment the polyolefin film is cross-linked by a method selected from group: silane moisture method, electron beam (EB) radiation and their combinations. The cross-linking can be made during the polyolefin film preparation or before the film is pressed onto the wood board. In one embodiment a cross-linking agent is used during the cross-linking. The cross-linking time depends on the thickness of the coating, relative humidity, temperature and diffusion constants of the polyolefin material.

In one embodiment the radiation dose is between 100-200 kGy, preferably 125-175 kGy, in radiation of the cross-linking.

In one embodiment of the invention the cross-linking density of the polyolefin film is 50-70%, in one preferable embodiment 55-67%.

In one embodiment of the invention the coating material is prepared by a catalyst. In one embodiment the catalyst is added to the silane grafted polyolefin. In one embodiment the catalyst is added to the silane grafted polyolefin prior to extrusion to accelerate the cross-linking reaction. The coating material can be prepared by using catalysts known per se.

In one embodiment of the invention polyolefin is selected from group: polyethylene, polypropylene and their combinations. In a preferable embodiment the polyolefin is polyethylene. The polyolefin film or each layer can include additives and fillers. In one embodiment the polyolefin film can contain filler of 0-40% by volume.

The polyolefin film and/or the film layers can be made from petrochemical and renewable feedstock materials. In addition to bio-based polymers can be used. Preferably, the bio-based polymers have processing temperature over 180° C. or over 190° C. In one embodiment, all film layers are substantially formed of the same material. In an alternative embodiment, at least one film layer is formed of a different material than the other films layers.

Compatibilisers can be added to the film in order to adhere the dissimilar polymers to each other.

In one embodiment of the invention the coating material comprises additives selected from group: reinforcement fibers, like glass-rock wool, carbon fibers, mineral particles, mineral fibers, glass fibers, quarts, aluminum oxides, UV protector and their combinations. In one embodiment the coating material contains additives up to 30% by volume.

In one embodiment of the invention polyolefin film contains reactive groups with —OH groups of the wood for forming a self-adhesive coating material and for forming covalent bonds between the wood board and polyolefin film. The polyolefin film is a self-adhesive by means of the reactive groups.

In one embodiment the polyolefin film contains maleated polyolefin which contains maleic anhydride reactive groups.

In one embodiment the polyolefin film contains iso-cyanate grafted polyolefin which contains reactive groups.

In one embodiment at least the second layer nearest the surface of the wood board is a self-adhesive layer so that it contains reactive groups with —OH groups of the wood.

In one embodiment the reactive groups of the polyolefin film is activated at temperatures of more than 180° C., in one embodiment at temperatures of more than 190° C., during the manufacturing of the self-adhesive material. In one embodiment, the sufficient time for activation is about 0.5-3 minutes. Then the film formed contains activated functional groups capable of forming the maximum number of covalent bonds with wood. The polyolefin films can be adhered directly to the wood when the film is maleated at least on one side and especially when the maleated layer is treated so that its temperature during manufacturing has been over 190° C., so that maleic acid is converted to maleic anhydride on the films surface. Maleic anhydride is very reactive with wood, forming a covalent bond with celluloses —OH groups. Without this activation, normal maleated film forms only hydrogen bonds, which are much weaker than covalent chemical bonds. So we also can bond polyolefin film directly to wood surface without any priming and joining layers.

In a preferred embodiment at least one polyolefin film layer contains maleic anhydride polyolefin. In a preferred embodiment the film or the film layer which includes maleated polyolefin also contains polymer e.g. polyethylene or polypropylene. Preferably, the film layer including maleated polyolefin essentially consists of MAPE+PE or MAPP+PP.

In one embodiment of the invention maleated polyolefin contains maleic acid 0.3-15% by weight of the maleated polyolefin, in one embodiment 1-5% by weight of the maleated polyolefin. Preferably, the film layer is maleated to the desired degree in order to improve friction and wetting properties of the coating material.

In one embodiment a catalyst is used in polyolefin film manufacturing. The catalyst increases the frequency of the covalent bonds formed between coupling agent, e.g. maleic anhydride, and wood. The polyolefin film can be prepared by using catalysts known per se.

The thickness of the coating may vary depending on the properties of the film materials and the application of the wood board. In one embodiment the polyolefin film has thickness between 1.5-3.0 mm, in one preferable embodiment is about 2.0-2.5 mm.

In one embodiment, the coating material can be prepared by using apparatuses and methods known per se, e.g. by extrusion or by co-extrusion.

The wood board can be made by using apparatuses and methods known per se. Laying the veneers one upon the other, joining them together and other typical steps in making the wood board can be performed in any manner known per se in the art. The coating can be arranged onto the wood board by using the hot pressing technique, extruder technique, film technique, roll application technique, cylinder application technique, coat and multi-layer coat application technique, all known per se, their combinations or a corresponding technique.

In one embodiment of the invention the coating material is attached onto the wood board at temperatures of 120-170° C. by hot-pressing. The self-adhesive coating material is attached onto the wood board by reactive groups. A benefit of one embodiment is that temperatures of only 120-140° C. are needed to fix the coating onto the wood board surface. The hot-pressing conditions, like temperature, pressure and time, depend on the wood type, e.g. spruce or birch, and polyolefin melting temperature.

In one embodiment, the coating material can be attached onto the wood board by gluing, e.g. by resin or glue.

The invention provides a heat and wear resistant coating and high friction coating. Further, the invention provides a simple and cheap solution for coating.

The wood board in accordance with the invention is suitable for various applications. The wood board can be used for applications, e.g. for floors, for floors in trucks or other transport vehicles and for heavy transport applications.

### LIST OF FIGURES

In the following, the invention is described by means of detailed embodiment examples with reference to accompanying FIGS. 1 and 2, in which

FIG. 1 shows polyethylene crystalline and amorphous material and tie molecules, and

FIG. 2 shows a coating material structure according to the invention.

### DETAILED DESCRIPTION OF THE INVENTION

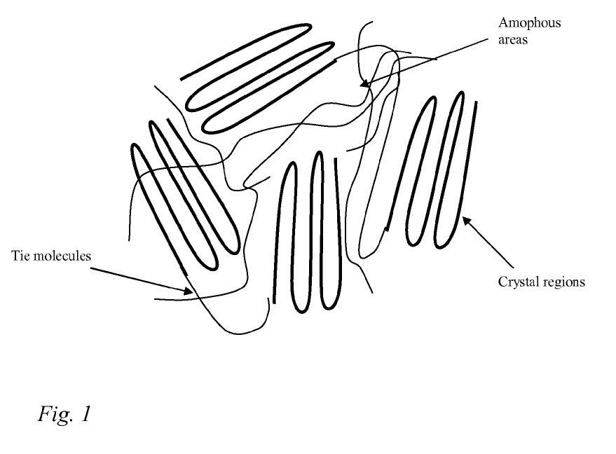

FIG. 1 discloses polyethylene crystalline and amorphous material and tie molecules.

In the test it was discovered that the heat-resistance of PE can be improved dramatically by cross-linking despite the fact that the irradiated and silane cross-linked materials still exhibit a melting point as shown by differential scanning calorimetry (DSC). However, the coating displays the properties normally associated with a solid such that the material does not appear to soften turn into a molten liquid even at elevated temperatures of 300° C. for short periods. It has also been observed that similar treatment to polyamide 66 does not yield the same degree of heat-resistance. In fact the polyamide melts to liquid.

In order to explain these observations it is necessary to consider the implications of irradiating a melt-crystallised, semi-crystalline polymer. It is well known that the irradiation process results in the cross-linking of the chains within an amorphous polymer and that within a semi-crystalline polymer, the process is more effective within the amorphous phase of the crystallites.

Therefore, it is envisaged that the cross-linking process results in a microstructure in which the crystalline lamellae are effectively constrained by the cross-linked amorphous regions. The polymer still exhibits a melting point as shown by differential scanning calorimetry (DSC), but a high degree of structural stability persists above the melting point because the uncross-linked, and previously crystalline lamellae, regions are effectively immobilised by the cross-linked amorphous layers. To explain why this effect is so pronounced in PE, the concept of a tie-molecule is also likely to be applicable.

Although the crystalline lamellae are often described as being chain-folded, the presence of chains that participate in the formation of a series of lamellae should not be ignored. If these tie-molecules are forced to cross-link with other chains in the amorphous regions of the polymer, further constrainment of the crystalline layers will result.

Although the crystalline layers may indeed melt in the thermodynamic sense and form an amorphous liquid, the associated chains are unlikely to exhibit the expected level of mobility at these elevated temperatures; the chains will be effectively bound into both amorphous and crystalline layer by virtue of the nature of tie-molecules. The coupling of the above phenomena may explain why PE behaves as a solid at temperatures in excess of the observed melting point.

Based on the above a semi-crystalline polymer that has crystallised in a form which is pre-dominantly chain folded, e.g. polyamide 66, will not respond favourably to irradiation i.e. cross-linking in the amorphous phase may well occur, but the level of constrainment of the lamellae regions post-melting will not be sufficient to impart any significant heat-resistance to the polymer. Conversely, a crystalline phase that has formed through random re-entry (FIG. 1) of the chains into multiple crystalline lamellae will have a tendency to exhibit tie-molecules that when cross-linked will effectively bind the crystalline layers together and impart a high degree of heat-resistance post-melting so that the polymer will not melt during the spinning test.

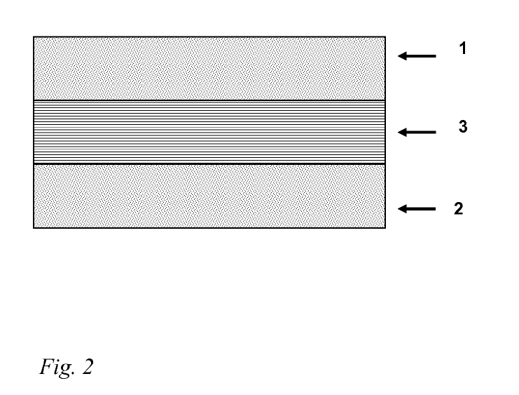

FIG. 2 discloses a coating material structure of the invention.

The coating material is formed of a polyethylene film which comprises three layers: first (1), second (2) and additive (3) layers. The first layer is a top layer (1), second layer is a bottom layer (2) nearest the surface of the wood board and additive layer (3) is arranged between the first and second layers.

The top (1) layer is formed of polyethylene which is cross-linked for forming a wear and heat resistant film layer. The bottom (2) layer is formed maleic anhydride polyethylene (MAPE) and polyethylene for forming a self-adhesive film layer.

The additive layer (3) is sandwiched between the top layer (1) and the bottom layer (2). The additive layer is formed of un-crosslinked polyethylene or polypropylene including additives and fillers, e.g. fire retardants.

The coating and the plywood used in the tests can be prepared following. At the first stage, the three-layer coating film according with FIG. 2 is prepared of polyolefin, maleated polyolefin and additives and fillers by co-extruding. The film can be optionally attached to non-woven or woven material. Maleated polyolefin of the second layer contains maleic acid which is converted maleic anhydride at temperatures of more than 190° C. during the manufacturing of the film. The first film layer is cross-linked by electron beam radiation. The layers of the film are joined together for forming the film. At second stage, the formed film is cut to size and is arranged onto the plywood by hot pressing or by gluing. The hot pressing is made at temperatures of about 130-140° C., at pressure of about 1.8 N/mm² and by time of about 13 minutes. The gluing can be made by hot-glues, e.g. by polyurethane.

When dissimilar polymers are co-extruded a compatibiliser material is required in the coating to join the dissimilar materials.

### Example 1

In this example, the coating material of FIG. 2 and the plywood of the invention were prepared and used in the tests.

The definition “Wisa-Truck” commercial coating means that on the plywood is pressed 6×(polyamide 66, 100 μm+Phenol formaldehyde resin impregnated 80 g/m² kraft paper having PF resolic resin content 140 g/m². The top layer is always a phenolic paper layer.

Here a special spinning test is developed for these applications. It is made with polyamide wheel of diameter 200 mm and width 90 mm. The wheel spins in place with a 30 000 N load and corresponding speed 5 km/h. If the surface does not melt in 20 s the test is accepted. This spinning test determines the resistance of a polymer better and more accurately than a standard test known in the art; this spinning test is a true measure of the polymers resistance to melt.

Rolling test was made according to SS 923502 standard, where metallic wheel is rolling over the sample with 300 kg load moving back and forth. The results are made by visual observations, 100 000 cycles gives our acceptance.

In this example following parameters were used in hot-pressing of the coating: hot-press temperature 120-135° C., hot-pressing time 13 minutes and hot-press pressure 1.8 MPa.

TABLE 1
Performance properties

| Coating | | | | Uncoated |
|---|---|---|---|---|
| properties | Coating 1 | Coating 2 | Wisa-Truc | plywood |
| Radiation Dose | 25 | 75 | — | — |
| kGy | | | | |
| Surface after | No change, | No change | No change | NA |
| 120° C. | S. | No change | No change | NA |
| hot press | compressed | | | |
| 130° C. | | | | |
| Fire test | 19 | 23 | 27 | 19 |
| ingnition | | | | |
| time (DIN | | | | |
| 5510), s | | | | |
| Brinell | 3.58 | 4.03 | Too hard | 2.38 |
| hardness | | | to | |
| (EN | | | measure | |
| 1543:2000) | | | | |
| Rolling test | 100 000 | 100 000 | 100 000 | — |
| (SS 923502) | | | | |
| cycles | | | | |
| Taper test | 20 000 | 20 000 | 19 600 | NA |
| abrasion value | 0.77 mm | 0.84 mm | | |
| (DIN 53799) | | | | |
| rounds | | | | |
| Spinning test | No | No | No | NA |
| 20 seconds | melting | melting | melting | |

S. compressed, means slightly compressed.

It can be seen from Table 1 that for either radiation dose (125 or 175 kGy) the coating is cross-linked sufficiently that it does not melt during the spinning test. However, owing to the need to hot-press (135° C.) the coating to the plywood up to 13 minutes there is some compression of the surface pattern in the case of the lower dose radiation. A lower hot-pressing temperature (120° C.) was also tested (120° C.) and while there was no compression of the surface pattern the glue did not fully cure. The coating that had the radiation dose of 175 kGy full-filled all the required criteria for the coating in that the it was heat and wear resistant without any compression of the surface pattern during hot-pressing to the plywood.

TABLE 2
Polymer properties

| | | | Un-cross- |
|---|---|---|---|
| Coating properties | Coating 1 | Coating 2 | linked PE |
| Radiation dose, kGy | 125 | 175 | — |
| Crystallinity (%) | 58.5 | 58.2 | 58.0 |
| Amorphous (%) | 41.5 | 41.8 | 42.0 |
| Crystallisation | 121.6 | 120.3 | 122.4 |
| temperature, ° C. | | | |
| Melting temperature, | 128.9 | 128.6 | 129.1 |
| ° C. | | | |
| Enthalpy (J/g) | 168.5 | 167.6 | 167.2 |
| Melt flow index | No melt | No melt | 9.9 |
| (g/10 min) | flow | flow | |
| Cross-linking density | 57.1 | 65.0 | 0 |
| (ASTM D2765-01) | | | |
| Spinning test | No melting | No melting | Melting |
| (20 seconds) | | | already in |
| | | | hot press |

From Table 2 it can be seen that the cross-linking density for coatings 1 and 2 is greater than the percentage amorphous material (16-24%). Also, there is no change in the percentage crystallinity and melting temperature. Therefore, there is no cross-linking of the crystalline part of the material. This supports the hypothesis that the polyethylene crystalline phase has formed through the random re-entry of chains into multiple crystalline lamellae and the tie molecules are tied together restricting the overall mobility.

TABLE 3
Performance properties

| | Coating 3 | Coating 4 | | Un- |
|---|---|---|---|---|
| | 20% glass | 20% glass, | Wisa- | coated |
| Coating properties | PEX 125 kGy | PEX 175 kGy | truck | plywood |
| Radiation dose | 125 | 175 | — | — |
| Surface pattern | No change | No change | No change | NA |
| 125° C. | S. | No change | No change | NA |
| after hot pressing | compressed | | | |
| 130° C. | | | | |
| Brinell Hardness | 3.60 | 4.04 | Too hard | 2.38 |
| (EN 1543:2000) | | | to | |
| | | | measure | |
| Rolling test | 100 000 | 100 000 | 100 000 | NA |
| (SS 923502)′ | | | | |
| cycles | | | | |
| Taper test abraser | 20 000 | 20 000 | 19 600 | NA |
| value | 0.90 mm | 0.91 mm | | |
| (DIN 53799), rounds | | | | |
| Spinning test | No melting | No melting | No | NA |
| (20 s) | but | but | melting | |
| | slight wear | slight wear | | |

It was not possible to measure the melt flow index (MFI) of the cross-linked coatings since the melt viscosity was too high. In fact the cross-linked polyethylene not only showed no melt flow it also kept its shape even when left in the oven for 30 minutes at 190° C. with a weight of 21.6 kg on it.

It is clear from the results in Table 3 the glass fibres at a percentage of 20% did not cause any problems with the cross-linking. Therefore it is possible to make heat and wear resistant coatings that are reinforced and offer better thermal shrinkage characteristics.

TABLE 4
Relative performance test for polyamide 66

| Coating properties | Coating 6 | Un-cross-linked PA 66 |
|---|---|---|
| Radiation dose, | 125 | NA |
| kGy | | |
| Surface pattern | No change | No change |
| after hot | | |
| pressing at 135° C. | | |
| Rolling test | 100 000 | NA |
| (SS 923502) | | |
| cycles | | |
| Melt flow index | No melt flow | |
| (g/10 min) | | |
| Crystallinity (%) | 22.6 | 23.8 |
| Amorphous (%) | 77.4 | 76.2 |
| Crystallisation | 218° C. | 235° C. |
| temperature | | |
| Melting temperature | 250.8° C. | 261.4° C. |
| Enthalpy (J/g) | 57.6 | 60.6 |
| Cross-linking | 97 | 0 |
| density (%) | | |
| Spinning test | Melted in 10 | Melted in 10 |
| | seconds | seconds |

Here (table 4) we can seen, that in spite of high cross-linking density the material passed the rolling test but not the spinning test.

The DSC results show a significant reduction in the melting point of the cross-linked polyamide 66 compared to uncross-linked polyamide 66. The melting temperature depression in the cross-linked sample may be attributed to a reduction in crystal size upon deposition of high-energy electrons. The cross-linking is still occurring predominantly in the amorphous phase; however, there is now also cross-linking and branching at the interface of the two regions which is the reason for the diminished crystallinity in the cross-linked sample. These results indicate that there is less crystalline material after cross-linking, and a change in the melting temperature. This could explain why in the case of polyamide 66 the cross-linking density was higher than the percentage amorphous material. The crystalline lamellar of polyamide is very often chain folded.

TABLE 5
Relative performance test for silane cross-
linked polyethylene

| Coating properties | | Coating 7 | Coating 8 |
|---|---|---|---|
| Catalyst Cat-MB420 (%) | | 3 | 5 |
| Cross- | Hot water bath | 1 | 1 |
| linking | 95-100° C. (hour) | | |
| time | | | |
| Surface pattern after hot | | TC | SC + Bubbles |
| pressing at 130° C. | | | |
| Rolling test(SS 923502) | | 100 000 | >100 000 |
| Cycles (wear of coating) | | | |
| Crystallinity (%) | | 57.6 | 59.2 |
| Amorphous (%) | | 42.4 | 40.8 |
| Crystallisation temperature | | 115.8 | 116.1 |
| Melting temperature | | 129.3 | 128.3 |
| Enthalpy (J/g) | | 168 | 183.5 |
| Cross-linking density (%) | | 56.3 | 61.8 |
| Spinning | Melting | No | No |
| test | Wearing | High | No |

SC means slightly compressed,
C means compressed,
TC means totally compressed and
NC means no change.

Here we can see from the compressed surface pattern after hot pressing and spinning tests that it is not necessary for the whole coating thickness to be cross-linked to prevent melting during spinning. Just the top layers of the coating need to be cross-linked but cross-linked to the sufficient cross-linking density to prevent melting during the spinning test. The bubbles observed in the coating are believed to be due to the catalyst and it is considered a catalyst concentration between 3-4% to be optimum.

TABLE 6
Relative performance test for silane cross-
linked polyethylene

| Coating properties | | Coating 7 | Coating 9 | Coating 10 | Coating 11 |
|---|---|---|---|---|---|
| Catalyst Cat-MB420 (%) | | 3 | 3 | 3 | 3 |
| Cross- | Hot water bath | 1 | 1 | 1 | 1 |
| linking | 95-100° C. (hour) | | | | |
| time | Saturated | — | | 1 | 4 |
| | steam (hour) | | | | |
| | 65% humidity | — | 5 | — | |
| | 23° C. (days) | | | | |
| Surface pattern after hot | | TC | TC | C | SC |
| pressing at 130° C. | | | | | |
| Rolling test(SS 923502) | | 100 000 | >100 000 | >100 000 | >100 000 |
| Cycles (wear of coating) | | | | | |
| Cross-linking density (%) | | 56.3 | — | — | 74.2 |
| Spinning | Melting | No | No | No | No |
| test | Wearing | High | High | High | No |

SC means slightly compressed,
C means compressed,
TC means totally compressed and
NC means no change.

The best conditions (Table 6) for cross-linking by moisture cross-linking are 5 hours over steam or in a boiling water bath. In the case of all the coatings the cross-linked polyethylene did not melt in the spinning test, however there was a lot of wearing of the coating when it was not treated for long enough. It is considered that the coating cross-links from the outside of the coating into the middle. Therefore the reason the coatings passed the spinning test was because the top layers of the coating were sufficiently cross-linked but the middle part of the coating was not which explains why during the hot-pressing the pattern was compressed.

TABLE 7
Relative performance test for silane cross-
linked polyethylene

| Coating properties | | Coating 8 | Coating 12 | Coating 13 | Coating 14 |
|---|---|---|---|---|---|
| Catalyst | | 5 | 5 | 5 | 5 |
| Cat-MB420/Borealis (%) | | | | | |
| Cross- | Hot water bath | 1 | 1 | 1 | 1 |
| linking | 95-100° C. (hour) | | | | |
| time | Saturated | — | — | 1 | 4 |
| | steam (hour) | | | | |
| | 65% humidity | — | 5 | — | — |
| | 23° C. (days) | | | | |
| Surface pattern after hot | | SC + | SC + | NC | NC some |
| pressing at 130° C. | | Bubbles | Bubbles | | bubbles |
| Rolling test(SS 923502) | | >100000 | >100 000 | >100 000 | >100 000 |
| Cycles (wear of coating) | | | | | |
| Cross-linking density (%) | | 61.8 | — | — | 76.2 |
| Spinning | Melting | No | No | No | No |
| test | Wearing | No | No | No | No |

SC means slightly compressed,
C means compressed,
TC means totally compressed and
NC means no change.

Here (Table 7) we can see that when sufficient layers of the coating is cross-linked the coating is both wear and heat resistant.

Overall the radiation cross-linked coatings gave the best performance and appearance as a coating. However, the silane coatings were also acceptable with the right amount of catalyst and right moisture cross-linking conditions and time.

TABLE 8
Chemical resistance of cross-linked, un-
cross-linked polyethylene and Wisa-Truck

| | | | | | | | Wisa- | |
|---|---|---|---|---|---|---|---|---|
| | PEX-1 | | PEX-2 | | PE | | truck | |
| | 1 | 7 | 1 | 7 | 1 | 7 | 1 | 7 |
| Chemicals | day | days | day | days | day | days | day | days |
| Hydrochloric | 3 | 3 | 3 | 3 | 3 | 3 | 3 | 3 |
| acid (25%) | | | | | | | | |
| Sulphuric | 3 | 3 | 3 | 3 | 3 | 3 | 3 | 3 |
| acid (25%) | | | | | | | | |
| Nitric acid | 3 | 3 | 3 | 3 | 3 | 3 | 2 | 1 |
| (25%) | | | | | | | | |
| Acetic acid | 3 | 3 | 3 | 3 | 3 | 3 | 3 | 3 |
| (25%) | | | | | | | | |
| Sodium | 3 | 3 | 3 | 3 | 3 | 3 | 2 | 2 |
| Hydroxide | | | | | | | | |
| (25%) | | | | | | | | |
| Ammonia | 3 | 3 | 3 | 3 | 3 | 3 | 3 | 3 |
| (25%) | | | | | | | | |
| Methyl ethyl | 3 | 2 | 3 | 2 | 3 | 2 | 3 | 3 |
| ketone (MEK) | | | | | | | | |
| Acetone | 3 | 2 | 3 | 2 | 3 | 2 | 3 | 3 |
| Xylene | 3 | 2 | 3 | 2 | 3 | 2 | 3 | 3 |
| Petrol | 3 | 3 | 3 | 3 | 3 | 3 | 3 | 3 |
| Grease | 3 | 3 | 3 | 3 | 3 | 3 | 3 | 3 |
| Diesel oil | 3 | 3 | 3 | 3 | 3 | 3 | 3 | 3 |

3: means good resistance,
2: means moderately resistant,
1: means poor resistance and
0: no resistance (dissolves).

Chemical resistance of PEX 125 kGy and PEX 175 kGy compared to PE was similar. Wisa truck did show values 1 to 25% HNO₃ when all PE+PEX did show values 3. NaOH 25% solution did give value 2 for Wisa-Truck all PE+PEX coating did show value 3. With all other chemicals all these products did show value 3. Chemicals used were HCl 25%, H₂SO₄ 25%, acetic acid 25%, ammonia 25%, methyle ethyl ketone, acetone, xylene, gasoline, grease, diesel oil.

It is clear from the chemical resistant results (table 8) that cross-linking does not improve the chemical properties of polyethylene; however, there is also no decrease in chemical resistance. Polyethylene and cross-linked polyethylene are significantly more chemically resistant to nitric acid and sodium hydroxide than the current Wisa-truck. However, Wisa-truck is slightly more resistant to MEK, acetone and xylene. Overall cross-linked polyethylene is more chemically resistant than the current Wisa-truck.

A wood board according to the invention is suitable in its different embodiments for different types of applications.

The embodiments of the invention are not limited to the examples presented rather many variations are possible within the scope of the accompanying claims.

1. A coated wood board, in which the wood board is coated by a coating material wherein the coating material is formed of polyolefin film, and the polyolefin film is at least partially is cross-linked so that the percentage of cross-linking is 10-60% bigger than the polyolefin amorphous percentage for pinning two phases, crystalline and amorphous, together for forming a wear and heat resistant coating.

2. The wood board according to claim 1, wherein polyolefin is selected from group: polyethylene, polypropylene and their combinations.

3. The wood board according to claim 1, wherein the polyolefin film contains reactive groups with —OH groups of the wood for forming a self-adhesive coating material.

4. The wood board according to claim 1, wherein the polyolefin film contains maleated polyolefin which contains maleic anhydride reactive groups.

5. The wood board according to claim 1, wherein the polyolefin film comprises at least two layers and at least top layer is cross-linked.

6. The wood board according to claim 1, wherein the polyolefin film is at least partially is cross-linked with silane moisture method and/or with electron beam radiation.

7. The wood board according to claim 1, wherein the cross-linking density of the polyolefin film is 50-70%.

8. The wood board according to claim 1, wherein the coating material is prepared by extrusion or by co-extrusion.

9. The wood board according to any one of claims 1 to 8, characterized in that the coating material is prepared by a catalyst.

10. The wood board according to claim 1, wherein the coating material is attached onto the wood board by gluing.

11. The wood board according to claim 1, wherein the coating material is attached onto the wood board at temperature between 120 and 170° C. by hot-pressing.

12. The wood board according to claim 1, wherein the coating material comprises additives selected from group: reinforcement fibers, like glass-rock wool, carbon fibers, mineral particles, mineral fibers, glass fibers, quarts, aluminum oxides, UV protector and their combinations.
